(19) United States
(12) Patent Application Publication
(10) Pub. No.: US 2026/0294129 A1
(43) Pub. Date: Oct. 1, 2026

(54) CONTROL SYSTEM FOR HAPTIC CHAIR BASED ON AUDIO/VISUAL INPUTS

(71) Applicant: Irwin Seating Company, Grand Rapids, MI (US)

(72) Inventors: Michael S. Glass, Conklin, MI (US); Timothy J. Patalan, Saline, MI (US)

(21) Appl. No.: 19/630,596

(22) Filed: Mar. 27, 2026

Related U.S. Application Data
(60) Provisional application No. 63/779,403, filed on Mar. 28, 2025.

(51) Int. Cl. A47C 31/00; A47C 1/12; A47C 7/72; G06F 3/16; G08B 6/00; H04R 3/04

(52) U.S. Cl. CPC A47C 31/008; A47C 1/12; A47C 7/72; G06F 3/165; G08B 6/00; H04R 3/04; H04R 2430/01

(57) ABSTRACT

A method of controlling a haptic device disposed at a seating unit includes receiving a media input including at least one of an audio signal and a video signal. The method includes generating, based at least in part on processing of the media input, a control function corresponding to the media input. Based on the generated control function, a haptic device disposed at the seating unit vibrates to impart vibration at the seating unit.

### CROSS REFERENCE TO RELATED APPLICATION

The present application claims the filing benefits of U.S. provisional application Ser. No. 63/779,403, filed Mar. 28, 2025, which is hereby incorporated herein by reference in its entirety.

### FIELD OF THE INVENTION

The present invention relates generally to a seating unit, such as a chair, for cinema, Performing Art Centers (PAC), education, home entertainment, live entertainment or recording studios.

### BACKGROUND OF THE INVENTION

It is known to provide chairs that use a single haptic device to create an immersive experience by distributing the haptic output to known locations in the chair.

Typically, such vibrations are caused by multiple vibrating units attached at different parts of the chairs.

### SUMMARY OF THE INVENTION

The present invention provides a haptic system that includes a haptic device that mechanically interfaces with a chair or other structure. The haptic device operates to generate a vibration output that imparts vibration or movement of the structure in a desired profile or pattern and at desired frequencies and amplitudes. For example, a method of operating the haptic device disposed at the chair includes receiving a media input that includes an audio signal and/or a video signal. The method includes generating, based at least in part on processing of the audio signal and/or the video signal, a haptic control function corresponding to the media input. Based on the generated haptic control function, the haptic device vibrates to impart vibration at the seat portion of the chair and the back portion of the chair. Generating the haptic control function may include adding or adjusting frequencies of the audio signal based on visual elements present in the video signal. The haptic control function may be generated by using a key generated based on the audio signal and/or the video signal with a look up table (LUT) generated based on the design of the chair and haptic device.

These and other objects, advantages, purposes and features of the present invention will become apparent upon review of the following specification in conjunction with the drawings.

### BRIEF DESCRIPTION OF THE DRAWINGS

FIG. 1 is a side view of a chair with a haptic device for a vibrating system at a seat back of the chair;

FIG. 2 is a schematic diagram of the vibrating system;

FIG. 3 is a schematic view of a control panel of the chair;

FIG. 4A is a schematic view of a boost knob of the control panel;

FIG. 4B is a table showing operation ranges of the boost knob;

FIG. 5A is a schematic view of a split knob of the control panel;

FIG. 5B is a table showing operation ranges of the split knob;

FIG. 6A is a schematic view of an input knob of the control panel;

FIG. 6B is a table showing operation ranges of the input knob; and

FIGS. 7A-7C is another schematic diagram of the vibrating system.

### DESCRIPTION OF THE PREFERRED EMBODIMENTS

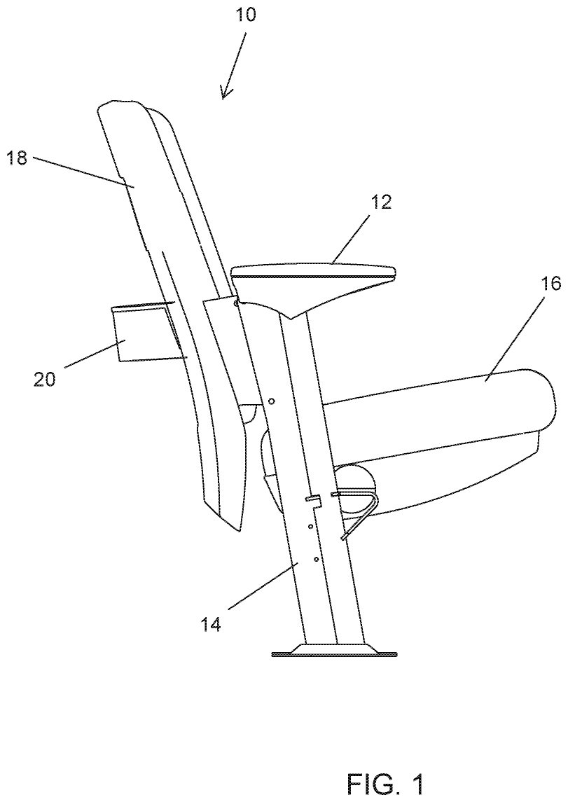

Referring now to the drawings and the illustrative embodiments depicted therein, an individual seating unit, such as a chair 10, may be part of a stadium or theater or auditorium seating configuration, which comprises a plurality of chairs arranged in rows (although only one chair is shown in FIG. 1). The individual chairs of the seating configuration may be arranged one next to another, optionally with an arm rest 12 at a stanchion 14 at each side of the chair 10. Each arm rest 12 between adjacent chairs of the row of chairs may be shared by the adjacent chairs. The chair 10 includes a seat or seat portion 16 and a back 18 both attached at respective stanchions, with the arm rest 12 and stanchion 14 at each side of the seat portion 16. The chair 10 includes an actuator or haptic device 20 that functions to vibrate an attaching plate that attaches the actuator at the back 18 of the chair. The actuator 20 operates to vibrate at different amplitudes and frequencies responsive to an input (that may correspond with video images being displayed and/or audio signals being broadcast at the seating area), whereby the vibrations are felt by a person sitting in the chair at different locations of the chair, including at different locations of the seat portion 16.

The actuator and chair cooperate to provide a “tunable chair” that converts the incoming electrical signal (provided to the actuator) to mechanical energy (haptic) and transfers this mechanical energy to different regions of the mechanism based on the mechanical interface design. The mechanical interface energy transfer can vary by amplitude, position and time. The system thus provides an enhanced experience with only a single haptic device, which has the ability to excite different regions of the mechanism or structure to give the desired effect to the user.

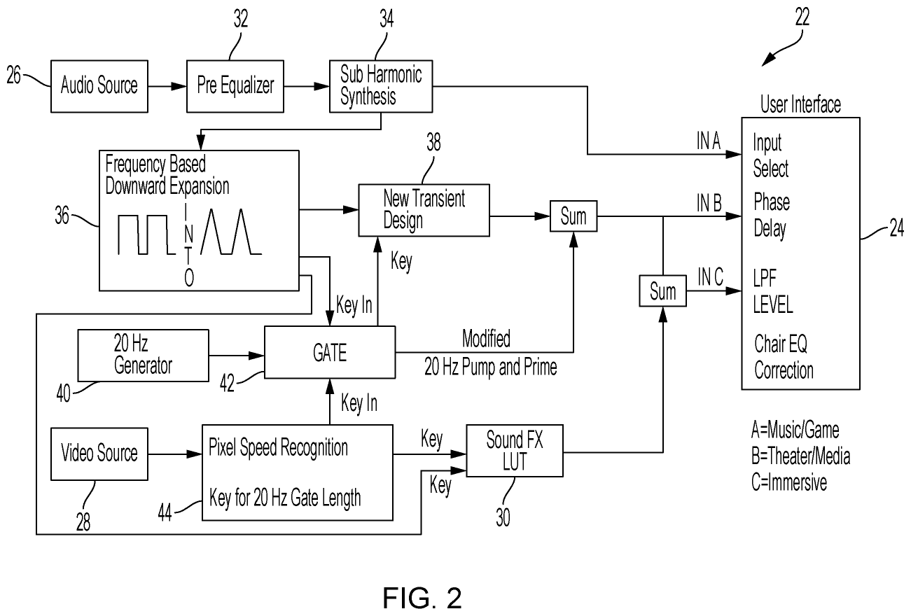

That is, and as shown in FIG. 2, a control system 22 generates outputs or a control function 24 for the actuator or haptic device 20, with the input being based on existing audio inputs or signals 26 and/or visual inputs or signals 28 that are to be experienced while the user is sitting in the chair. For example, the control system 22 may generate the output or function 24 (e.g., in a range of 1 Hz to 40 kHz) based on the corresponding music or sound effects and/or video that correspond to media (e.g., a movie, videogame, live music performance, music video, or recorded music) displayed to the user in the seating area. The haptic device 20 is configured to vibrate at the desired or set or programmed frequencies and amplitudes of the control function 24. The haptic device 20, which (in the illustrated embodiment of FIG. 1) is attached at the chair back, vibrates and, via the mechanical interface to the seat structure and/or mechanism, causes different portions of the chair (back and seat portion) to vibrate the desired amount and at the desired locations. The mechanical response is variable in both amplitude and position based on the input from the haptic device, thereby providing a tunable device or chair. For example, the chair may include characteristics of the tunable haptic chairs described in U.S. Patent Pub. No. US-2025-0331647, which is hereby incorporated herein by reference in its entirety.

Currently existing video and audio sources are sound optimized for existing subwoofer utilization. That is, existing video and audio signals may be configured for use with speaker systems and subwoofers. Subwoofers operate above the frequency range at which the haptic device 20 is better suited to transfer low frequency content. The haptic device 20 may also have the advantage of using lower power to transfer the same low frequency content versus a subwoofer.

As discussed further below, the control signals 24 generated for the haptic device 20 are optimized to take advantage of the chair 10 that is frequency response characterized or tuned using the haptic device 20. That is, the control system 22 uses the frequency and phase response of the chair 10. This frequency and phase information (FPI) may be derived from modal analysis, accelerometer-based analysis, and the like. The FPI may be given a mathematical value to be applied to a look up table (LUT) 30. The LUT 30 is derived and optimized to apply the desired low frequency content to the haptic device 20. The FPI gives the ability in real time to translate the LUT 30 for improved haptic response.

In other words, the control signals 24 causing the haptic device 20 to vibrate the chair 10 may be generated based on specific structure and material of the chair 10, represented by the FPI. The LUT 30 is generated based at least in part on the FPI. Audio signals 26 and/or visual signals 28 from existing media may be processed and/or adjusted by the control system 22 and used as a key for the LUT 30 to determine at least a portion of the control function 24.

In the illustrated example, the audio signals 26 may first be processed with one or more of a low shelf filter, a boost equalizer (EQ) filter and a low pass filter or pre-equalizer 32. Most audio program material is deficient or non-existent below about 50 Hz, so a subharmonic synthesis module 34 generates subharmonics from the program material or audio signals 26 and adds the subharmonics to the filtered audio signals to extend the low frequency response below about 50 Hz, such as between about 1 Hz and 50 Hz. Audio signals that are processed for typical subwoofer playback, such as movie and sound effect tracks, lack the appropriate dynamics to generate the haptic outputs, so a downward expansion stage 36 that creates sharper and more pronounced transients' detection at about 60 HZ helps differentiate between impact sounds and rumble in the generated key for the haptic outputs 24.

Put another way, the pre-equalizer 32 may be applied to the audio signals 26, which may be sourced from existing audio (e.g., from music and/or movie soundtracks and sound effects). The subharmonic synthesis module 34 adds subharmonics to the audio signals 26 to provide range or depth below about 50 Hz. These modified or adjusted inputs may be subjected to a frequency based downward expansion stage 36 to generate sharper signals at about 60 Hz. Following the downward expansion stage 36, the modified audio signals or key may be transmitted to a transient design module 38. At least a portion of the key generated following the downward expansion stage 36 may be processed via the LUT 30.

In some examples, a low frequency oscillator 40, such as a 20 Hz oscillator, is gated and triggered to open when instructed. That is, the low frequency oscillator 40 may generate frequencies at about 20 Hz or less and a gate 42 may block the low frequency oscillator 40 from adding such low frequencies to the key unless instructed. When added, this tone jump starts the chair 10 to receive higher impact audio and lengthens the peak of impact to a more aesthetically pleasing response curve.

The decay and release settings are derived from several sources, including downward expanded audio/visual detection, and the transient design module 38. For example, the video signals 28 may be processed via a pixel speed recognition module 44 to determine whether to release the gate 42 and thus allow the low frequency oscillator 40 to generate low frequency. Visual elements of the video signals 28 may trigger release of the gate 42. For example, fast pixel movement followed by a sudden stop in the video signals 28 may imply long decay and rumbling, and fast pixel movement followed by edits in the video signals 28 may imply shorter impact response curves. The transient design module 38 shapes the response curve of the audio peaks into a chosen decay shape, at times independent of the existing transient decay shape.

Thus, the pixel speed recognition module 44 may process the video signals 28 to determine adjustments and/or additions to the haptic outputs 24 that may not be represented in the corresponding audio signals 26. For example, an explosion may be visible in the background of the video signals 28 and a haptic output 24 representative of an approaching shockwave may be generated before audio signals 26 representative of the explosion or shockwave are present in the media track. A key generated by the module 44 may be processed via the LUT 30 to generate at least a portion of the control function 24. Moreover, the module 44 may trigger the release of the gate 42 to pass through low frequency outputs from the low frequency oscillator 40 to the haptic device 20. Modification of the response curves of the audio peaks into decay shapes may be based at least in part on the processing of the video signals 28 by the pixel speed recognition module 44.

In some examples, the control function 24 may be generated based at least in part on an operating mode of the system 22 and/or a type or classification of the media input. For example, in a first mode or music/game mode, the control function 24 may be generated based on the modified audio signals following addition of the subharmonics (e.g., A in FIG. 2). In a second mode or theater/media mode, the control function 24 may be generated based on a sum of the shaped audio peaks from the transient design module 38 and the low frequency generated by the low frequency oscillator 40 (e.g., B in FIG. 2).

This may correspond to a phase delay. In a third mode or immersive mode, the control function may further be generated based on the modified audio signals and video signals via the LUT 30 (e.g., C in FIG. 2). This may correspond to a low-pass filter (LPF) level. Immersive/LUT playback may include intelligence in the form of human creation or artificial intelligence (AI) assisted tracking.

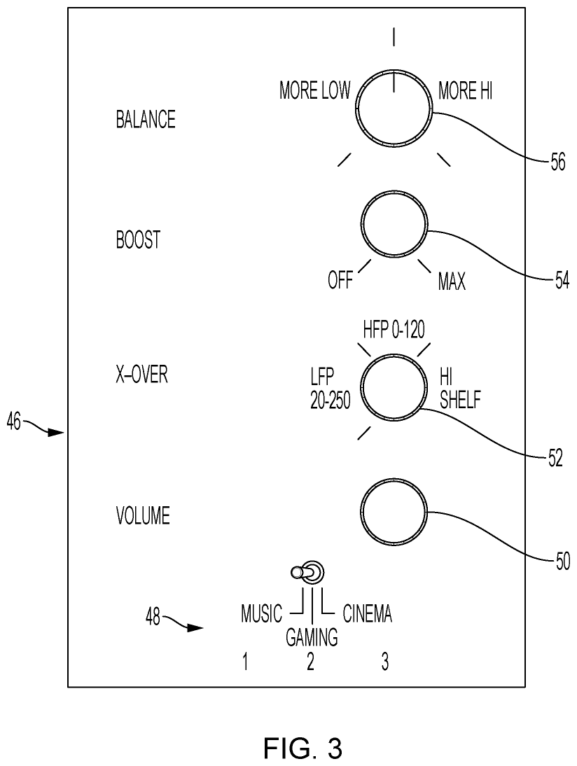

As shown in FIG. 3, a control panel or control unit 46 includes one or more switches, knobs, toggles, sliders or other inputs for adjusting operation of the control system 22. The control panel 46 may be disposed at the chair 10 so that the user may adjust operation of their individual chair 10, or the control panel 46 may be disposed remote from the chair 10. For example, the control panel 46 may be disposed remote from the chair 10 so that an operator at a venue (e.g., a theater) may adjust operation of the control system 22 at one or more chairs 10. Thus, the control panel 46 may adjust operation of one or more chairs 10 so that the operator may control up to each chair 10 in the venue through inputs at one control panel 46.

The control panel 46 includes a mode adjustment input 48 (e.g., a switch or toggle) for adjusting the control system 22 between two or more operating modes, such as the music mode, a gaming mode, the cinema or theater mode, an immersive mode and the like. Moreover, the control panel 46 includes a volume adjustment input 50 (e.g., a knob or slider), an X-over adjustment or split adjustment input 52 (e.g., a knob or slider), a boost adjustment input 54 (e.g., a knob or slider), and/or a balance or input or mix adjustment input 56 (e.g., a knob or slider). As discussed further below, inputs at the control panel 46 may affect how the control system 22 processes the audio signals 26 and/or the video signals 28 for generating the control function 24 that controls operation of the actuator 20 at the chair 10. Further, inputs at the control panel 46 affect processing of the signals in a specific order.

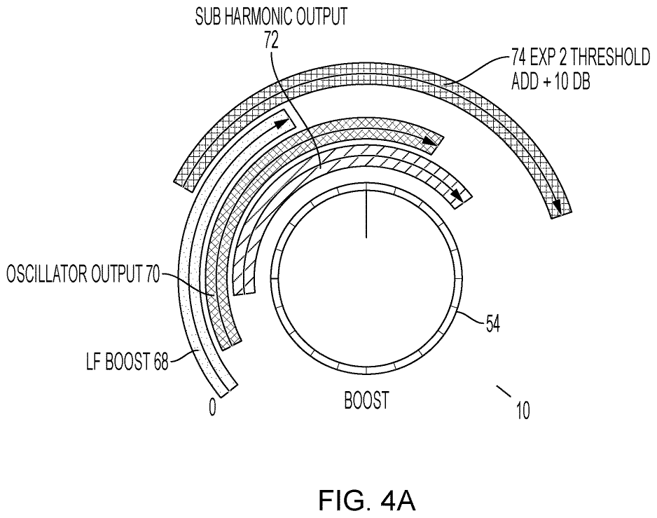

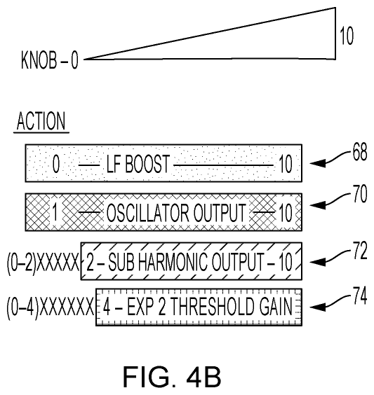

For example, and referring to FIGS. 4A-7C, the control system 22 may receive audio inputs 26 and/or video inputs 28 for generating a low frequency (LF) output or portion 24a of the control signal 24 and a high frequency (HF) output or portion 24b of the control signal 24. The LF output 24a may control operation of the actuator 20 and the HF output 24b may control operation of audio speakers. Optionally, the LF output 24a and the HF output 24b may both contribute to control of the actuator 20 and/or audio speakers.

The volume knob 50 may at least partially control an input gain module 58, which transmits stereo audio input signals 26 to a HF delay module 60 and transmits stereo audio input signals 26 to a stereo-to-mono conversion module 62, which converts the stereo audio input signals to mono audio inputs. The volume knob 50 provides a multi-function control that sets playback level, and balance between HF output 24b and LF output 24a throughout the control range. For example, lowering the volume may increase the relative volume of the LF output 24a to the HF output 24b so that the LF output 24a remains perceptible. In open-air environments, LF may be imperceptible to human ears.

Increasing the relative amplitude of LF outputs 24a at the chair 10 improves the perception of the LF outputs 24a when the audio volume of the HF outputs 24b is decreased. The playback level and balance may be set by the control system 22 via specific fader tapers. For example, a setting of 7 out of 10 at the volume knob 50 may represent unity input gain and no output attenuation. LF and HF output attenuation and gain fader curves above and below the unity setting are set in accordance with perception research (e.g., FPI).

From the stereo-to-mono conversion module 62, a first expander 64 (e.g., a downward expander) and a pre-EQ 66 are applied to the key. In some examples, such as in the music mode, a low shelf boost module 68 may be applied to the key. That is, the boost knob 54 (FIGS. 4A and 4B) may be adjustable between a minimum level and a maximum level, such as between 0 and 10 in the illustrated example. The boost knob 54 provides master low frequency enhancement control, affecting sub-harmonic generation, oscillator and sample level. Adjusting the boost knob 54 up from zero gradually raises the low shelf EQ 68 on the program material, the level of a first oscillator bank 70 and the sub-harmonic signal output 72. As the boost knob 54 value is increased, the threshold of a second expander 74 is incrementally increased to additionally shape the transient wave for clarity and performance.

In other words, as the boost knob 54 is increased (e.g., from 0 to 10), the LF boost 68 to the signal increases and the output from the first oscillator bank 70 to a third expander module 76 increases. Further, at higher levels of the boost knob 54 (e.g., from 2 to 10), the signal from the sub-harmonic output module 72 is increased and at higher levels of the boost knob 54 (e.g., from 4 to 10), the threshold of the second expander 74 is increased. For example, the second expander 74 may minimize or reduce or eliminate frequencies below the threshold and maximize or boost or increase frequencies above the threshold. The second expander 74 and the third expander 76 may have a shared key input from a sum of the pre-EQ 68 and an audio sampler or LUT 30. Sum of the sub-harmonic output 72, the third expander module 76, and the audio sampler 30 may be volume-controlled based on the input from the boost knob 54 for the LF output 24a.

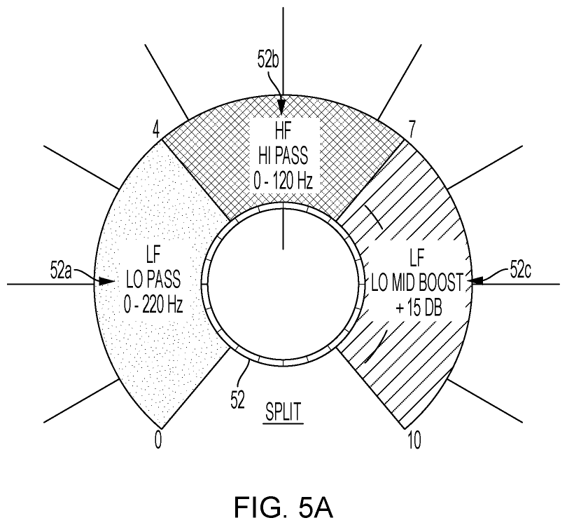

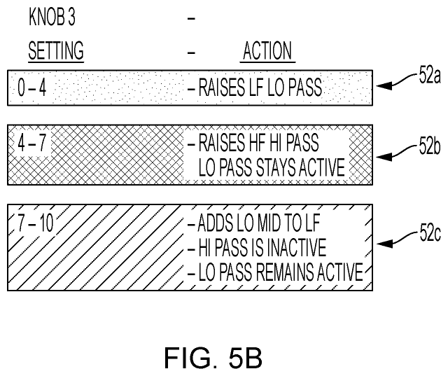

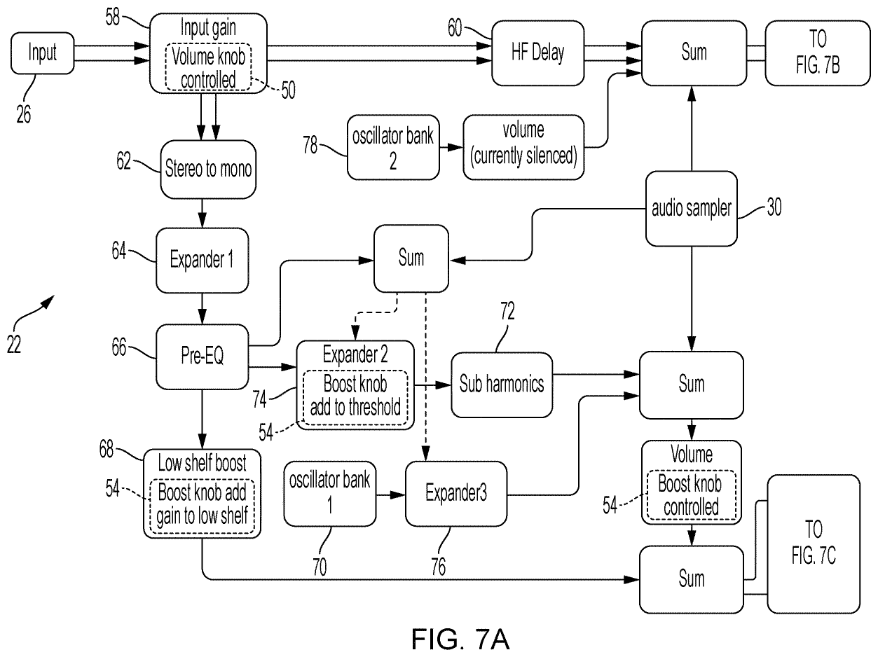

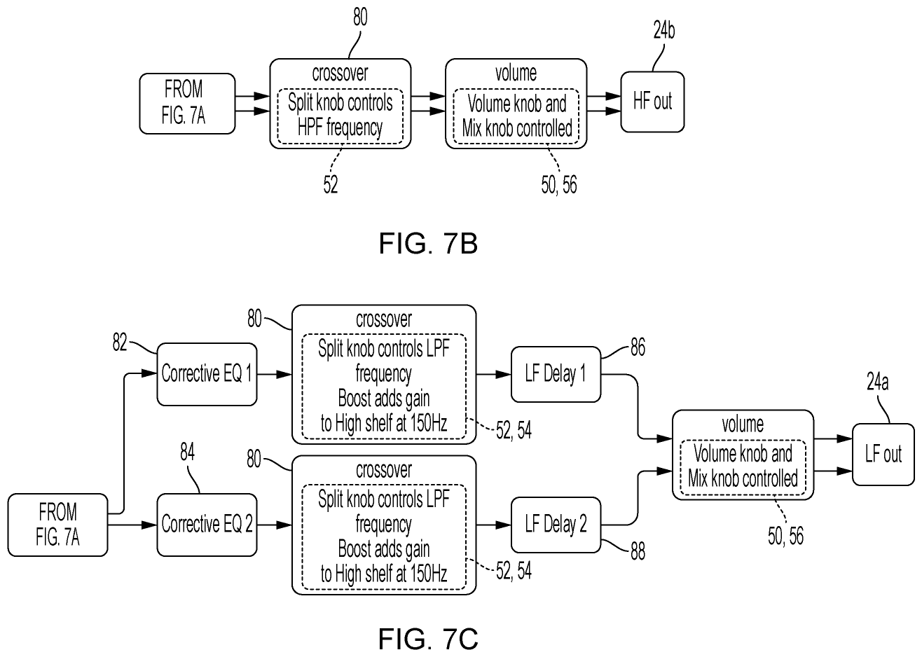

From the HF delay module 60, sum of the HF delay module 60, the audio sampler 30, and a volume-controlled second oscillator bank 78 may be provided for the HF output 24b. Referring to FIGS. 7B and 7C, the split knob 52 (FIGS. 5A and 5B) provides a multi-use crossover setting at crossover modules 80 for the LF output 24a and the HF output 24b. The LF output 24a may first pass through a first corrective EQ module 82 and a second corrective EQ module 84 (e.g., if the LF output 24a is split from mono to stereo). Adjusting the split knob 52 up from zero moves the control from a first low pass filter on the LF output 24a for a first portion 52a of the knob movement (e.g., a first third of the range of the spit knob 52). In other words, as the split knob 52 is increased within the first portion 52a (e.g., between about 0 and 4), the crossover module 80 raises the LF low pass filter (e.g., between about 0 Hz and 220 Hz). Adjusting the split knob 52 for a second portion 52b of the knob movement (e.g., a second or middle third of the range of the split knob) adds high pass filter control on the HF output 24b. That is, as the split knob 52 is increased within the second portion 52b (e.g., between about 4 and 7), the crossover module 80 raises the HF high pass filter (e.g., between about 0 Hz and 120 Hz) and the LF low pass filter remains active. Adjusting the split knob 52 for a third portion 52c of the knob movement (e.g., a final third of the range of the split knob) removes the HF high pass filter while engaging a low mid EQ boost. That is, as the split knob 52 is increased within the third portion 52c (e.g., between about 7 and 10), the crossover module 80 adds low mid to the LF output 24a, while the LF low pass filter remains active and the HF high pass filter is inactive. This lifts the HF output 24b to the chair 10 until the chair 10 is unable to produce the HF output 24b (e.g., about 300 Hz or higher, about 400 Hz or higher, and the like).

That is, the third portion 52c of the split knob 52 may cause the chair 10 to produce audible frequencies in the HF range, supplementing audible HF outputs 24b (e.g., from a speaker system) by up to 15 dB or more. Thus, the final third of adjustment is used for balancing low level monitoring levels, and may be for hearing impaired user applications.

At the crossover module 80, the boost knob 54 may add gain to the high shelf at about 150 Hz of the LF output 24a. Moreover, the LF output 24a may first pass through a first LF delay module 86 and a second LF delay module 88.

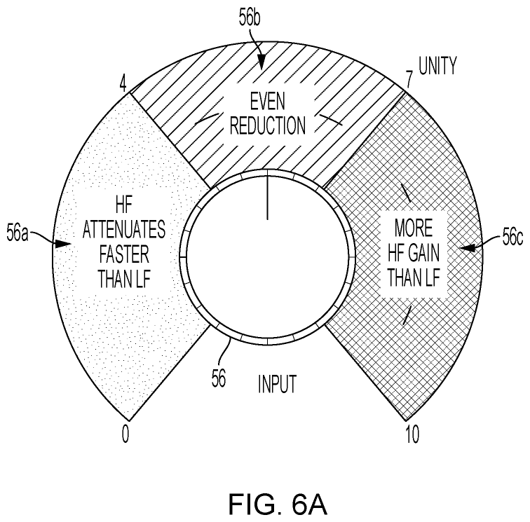

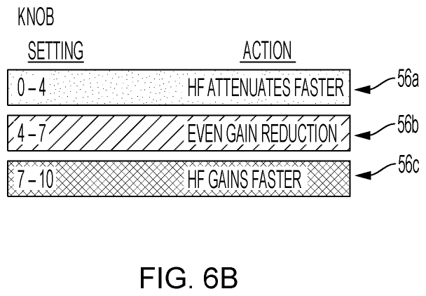

The balance or input knob 56 (FIGS. 6A and 6B) adjusts the relative levels of LF output 24a to the HF output 24b. For example, adjustment of the balance knob 56 within a first portion 56a (e.g., between about 0 and 4), may cause the HF output 24b to attenuate faster than the LF output 24a. Adjustment of the balance knob 56 within a second portion 56b (e.g., between about 4 and 7), may cause the HF output 24b and the LF output 24a to experience equal gain reduction. Adjustment of the balance knob 56 within a third portion 56c (e.g., between about 7 and 10), may cause the HF output 24b to gain faster than the LF output 24a. Thus the balance knob 56, when adjusted to the left of center, may decrease the HF output 24b (e.g., to the chair 10 and/or speaker) while adjusting to the right decreases the LF output 24a.

In some examples, the LF output 24a may be transmitted to the chair 10 and the HF output 24b may be transmitted to speakers (or a greater proportion of the LF output 24a may be transmitted to the chair 10 than to the speakers and a greater proportion of the HF output 24b may be transmitted to the speakers than to the chair 10). Thus, low frequency may be achieved directly at the chair 10 while high frequency may be broadcast within the room or venue. For example, in a sound room, low frequency may not be transmitted through open air equally to different portions of the room. Use of the chair 10 ensures that users at different positions within the room may perceive the same low notes. Use of the chair 10 also allows for the reduction of low frequency audio based on supplemental chair low frequency (e.g., to allow for reduced noise exposure for sound engineers or employees in a venue).

Thus, the control system 22 provides SMART LEVEL™ capabilities, where the digital signal processing (DSP) of the control system 22 results in a crossover, tactile audio listening system that balances LF and HF output across the DSP output range. This is accomplished by encoding the DSP output control with a taper curve determined by the tactile perception research (e.g., FPI). This allows LF program material to be perceived at loud and quiet volumes with the same precise balance in respect to the accompanying HF program material. This is possible because of the increased dynamic range tactile vibrational low frequency perception versus air transmission transducers. In other words, smart-leveling may adjust the relative output of the LF program material (e.g., LF audio at a speaker system and LF haptic output at the chair) to the output of the HF program material (e.g., at the speaker system) to ensure that the full range of frequencies are perceptible at all output levels. For example, the volume or amplitude of LF outputs may be increased relative to HF outputs at low overall volumes or amplitudes to ensure that the LF outputs remain perceptible. Accordingly, the haptic output at the chair 10 improves overall perception of LF outputs at lower volume levels.

Moreover, the control system may provide WAVESHAPING™ capabilities, where the high power haptic device 20 is controlled based on a proprietary audio sample or LUT 30. The substance of the sample or input itself is fundamental in creating the characteristic feel of a tactile listening device. This also allows for real time input, such as music instrument microphones or media playback, to exhibit the sample amplitude/waveform shape as the controlling sample. Its use is crucial in the suppression of audio feedback in haptic driven listening to devices in live music and audio performance settings. Activation of the WAVESHAPING™ capabilities is achieved through triggering the audio sample or LUT via an incoming audio signal to the DSP and/or targeted DSP frequency detection and/or through transmitting midi signals to the DSP immersive control channel (ICC).

Thus, the control system 22 drives an oscillator or haptic actuator 20 at the chair 10 using a key or control signal 24 that is derived from incoming audio inputs 26 and/or proprietary samples or a LUT 30. The control signal 24 may include subharmonics generated based on the incoming audio inputs 26 and/or samples 30. In some examples, the key derived from incoming audio inputs 26 is supplemented or combined with the generated subharmonics to provide a mask for the subharmonic generation latency.

The audio spectrum is reproduced accurately at high and low intensities by use of proprietary tapered amplitude and EQ curves applied to the master volume output. The DSP volume control activation is affecting both HF and LF outputs. The same filtering coupled with dynamic limiting facilitates the intelligibility of program material to hearing impaired users by raising frequencies in the vocal and instrument range by keeping the signal above the user tactile detection threshold.

In some examples, subharmonic generation, oscillator use and/or sample playback is used to expand the dynamic range beyond the source media's existing range. For example, expanders and/or low frequency generators may be used to expand the LF outputs to perceptible levels. Moreover, video inputs may be used to generate haptic outputs. That is, the audio sample may be applied based on video inputs to control the haptic output and impart a specific feel to the user. For example, an onboard sample playback may indicate the occurrence of an event or an intensity of the event where the sample is activated by an incoming audio signal, mid signal or visual signal.

In crossover use, the haptic output may be balanced with the high frequency output at various listening levels by applying a fader taper that raises or lowers the haptic output in a measured amount at the chosen playback level. The fader taper is derived from perception testing and follows a precise, decibel-corresponding output adjustment. This uses EQ curves to assist hearing and intelligibility by keeping signals above a tactile threshold (e.g., for hard of hearing listeners).

In the illustrated embodiment, the actuator or haptic device is disposed at the chair back 18. However, the actuator may be disposed at the seat portion 16 of the chair 10, depending on the particular application. Also, the chair is shown as an auditorium or theater chair that has the seat portion pivot up when not in use. However, aspects of the actuator and haptic system may be implemented on various seating applications or seating units, such as cinema, performing art centers, live entertainment, auditoriums, educational seating, home entertainment use, and the like. For example, the haptic device 20 may be disposed at other seating units like a stool (i.e., having only a seat portion and not having a back portion) so that operation of the haptic device 20 vibrates or excites different portions or regions of the seat portion of the stool. In some examples, the seating unit may comprise an insert or plate or panel disposed within a chair or stool or couch or other furniture piece (e.g., disposed within a cushion of the furniture piece), such that the haptic device 20 may be disposed at the insert and disposed at least partially within the furniture piece for imparting vibration of at least a portion of the furniture piece. Also, aspects of the actuator and haptic system may be implemented in non-seating applications, where the actuator operates to provide a desired and tunable haptic response at a selected device or structure. Optionally, the haptic device 20 may be disposed at a bed or mat or panel (e.g., a flat bed or a bed having a contoured cavity configured to at least partially receive a user) so that operation of the haptic device 20 vibrates or excites different portions or regions of the bed so that the user perceives the vibration at different regions of their body engaged with the bed. FPI analysis may be derived for any substrate for use with the haptic device 20.

According to an aspect of the disclosure, a method of controlling a haptic device disposed at a seating unit includes receiving a media input including at least one of an audio signal and a video signal. The method includes generating, based at least in part on processing of the media input, a control function corresponding to the media input. Based on the generated control function, a haptic device disposed at a seating unit vibrates to impart vibration at the seating unit. Implementations of the disclosure may include one or more of the following optional features.

In some implementations, the media input includes the audio signal, and generating the control function includes adjusting frequencies of the audio signal. In further implementations, adjusting frequencies of the audio signal includes applying an EQ filter.

The EQ filter includes at least one of (i) a low shelf filter, (ii) a boost EQ filter and (iii) a low pass filter. In further implementations, generating the control function includes adding subharmonic frequencies to frequencies of the audio signal. In further implementations, generating the control function includes adjusting frequencies of the audio signal via frequency-based downward expansion. In further implementations, generating the control function includes adjusting the audio signal to modify response curves of the audio signal into chosen decay shapes.

In some examples, generating the control function includes activating a low frequency oscillator responsive to a trigger. In further examples, the media input includes the video signal, and the trigger includes a visual element present in the video signal.

In some aspects, generating the control function includes applying a key to a look up table. In further aspects, the key is generated based on at least one of the audio signal and the video signal. In further aspects, the look up table is based at least in part on frequency and phase information of the seating unit.

In some implementations, the media input includes the video signal. The control function is generated based on visual elements present in the video signal.

In some examples, the media input includes the audio signal and the video signal. Generating the control function includes adjusting frequencies of the audio signal based at least in part on visual elements present in the video signal.

In some aspects, the control function is generated based at least in part on frequency and phase information of the seating unit.

In some implementations, the seating unit includes a chair including a seat portion and a back portion. The haptic device is disposed at one of the seat portion and the back portion. The haptic device imparts vibration at the seat portion and the back portion. In other implementations, the seating unit includes a stool.

In some examples, the method further includes adjusting the control function based on a user input. In further examples, the control function includes a low frequency portion and a high frequency portion. The haptic device vibrates based on the low frequency portion of the control function. A speaker system generates an audio output based on the high frequency portion.

In even further examples, the user input includes a volume selection between a minimum volume input and a maximum volume input. Based on the volume selection including a first volume level, the relative amplitude of the low frequency portion to the high frequency portion is set to a first value. Based on the volume selection including a second volume level less than the first volume level, the relative amplitude of the low frequency portion to the high frequency portion is set to a second value greater than the first value.

In even further examples, the user input includes a boost selection between a minimum boost input and a maximum boost input. In response to the boost selection increasing between the minimum boost input and the maximum boost input, (i) a low shelf EQ filter applied to frequencies of the audio signal increases and (ii) an oscillator bank output to an expander module applied to frequencies of the audio signal increases. In additional even further examples, in response to the boost selection increasing between a first intermediate boost input and the maximum boost input, an output from a sub-harmonic output module applied to frequencies of the audio signal increases, and wherein the first intermediate boost input is greater than the minimum boost input. In other additional even further examples, in response to the boost selection increasing between a second intermediate boost input and the maximum boost input, a threshold at which the expander module is applied to frequencies of the audio signal increases, and wherein the second intermediate boost input is greater than the first intermediate boost input.

In even further examples, the user input includes a split selection between a minimum split input and a maximum split input. In response to the split selection increasing between the minimum split input and a first intermediate split input, a low pass filter applied to the low frequency portion of the control function increases. In response to the split selection increasing between the first intermediate split input and a second intermediate split input greater than the first intermediate split input, the low pass filter is applied to the low frequency portion of the control function and a high pass filter is applied to the high frequency portion of the control function. In response to the split selection increasing between the second intermediate split input and the maximum split input, the low pass filter is applied to the low frequency portion of the control function and low mid is applied to the low frequency portion of the control function.

In even further examples, the user input includes a balance selection between a minimum balance input and a maximum balance input. In response to the balance selection decreasing between the minimum balance input and a first intermediate balance input, the high frequency portion of the control function attenuates at a greater rate than the low frequency portion of the control function. In response to the balance selection adjusting between the first intermediate balance input and a second intermediate balance input greater than the first intermediate balance input, the high frequency portion of the control function and the low frequency portion of the control function gain at an equal rate. In response to the balance selection increasing between the second intermediate balance input and the maximum balance input, the high frequency portion of the control function gains at a greater rate than the low frequency portion of the control function.

Another aspect of the disclosure provides a method of controlling a haptic device disposed at a seating unit. The method includes receiving a media input including an audio signal and a video signal. The method includes generating, based at least in part on processing of the media input, a control function corresponding to the media input.

Generating the control function includes adjusting frequencies of the audio signal based at least in part on visual elements present in the video signal. The control function is generated based at least in part on frequency and phase information of the seating unit.

Based on the generated control function, a haptic device disposed at a seating unit vibrates to impart vibration at the seating unit. This aspect may include one or more of the following optional features.

In some implementations, generating the control function includes activating a low frequency oscillator responsive to a trigger. The trigger includes a visual element present in the video signal.

In some examples, generating the control function includes applying a key to a look up table. The look up table is based at least in part on the frequency and phase information of the seating unit. In further examples, the key is generated based on at least one of the audio signal and the video signal.

In some aspects, the seating unit includes a chair including a seat portion and a back portion. The haptic device is disposed at one of the seat portion and the back portion. The haptic device imparts vibration at the seat portion and the back portion.

Yet another aspect of the disclosure provides a seating unit. The seating unit includes a seat portion. A control module generates a control function based at least in part on processing of a media input. The media input includes an audio signal. The seating unit includes a haptic device that, based on the control function, vibrates to impart vibration at least at the seat portion of the seating unit. The control function is generated based at least in part on adjusting frequencies of the audio signal. The control function is generated based at least in part on frequency and phase information of the seating unit. This aspect may include one or more of the following optional features.

In some implementations, the control function is generated based at least in part on applying a key to a look up table. The look up table is based at least in part on the frequency and phase information of the seating unit. In further implementations, the key is generated based on the audio signal. In other further implementations, the media input includes the audio signal and a video signal, and the key is generated based on at least one of the audio signal and the video signal.

In some examples, the seating unit includes a chair including the seat portion and a back portion. The haptic device is disposed at one of the seat portion and the back portion. The haptic device imparts vibration at the seat portion and the back portion.

In some aspects, the control module is disposed remote from the seating unit.

Optionally, the control module is disposed at the seating unit.

Changes and modifications in the specifically described embodiments can be carried out without departing from the principles of the invention, which is intended to be limited only by the scope of the appended claims, as interpreted according to the principles of patent law including the doctrine of equivalents.

1. A method of controlling a haptic device disposed at a seating unit, the method comprising:
receiving a media input comprising at least one selected from the group consisting of (i) an audio signal and (ii) a video signal;
generating, based at least in part on processing of the media input, a control function corresponding to the media input; and
wherein, based on the generated control function, a haptic device disposed at a seating unit vibrates to impart vibration at the seating unit.

2. The method of claim 1, wherein the media input comprises the audio signal, and wherein generating the control function comprises adjusting frequencies of the audio signal.

3. The method of claim 2, wherein adjusting frequencies of the audio signal comprises applying an EQ filter, and wherein the EQ filter comprises at least one selected from the group consisting of (i) a low shelf filter, (ii) a boost EQ filter and (iii) a low pass filter.

4. The method of claim 2, wherein generating the control function comprises adding subharmonic frequencies to frequencies of the audio signal.

5. The method of claim 2, wherein generating the control function comprises adjusting frequencies of the audio signal via frequency-based downward expansion.

6. The method of claim 2, wherein generating the control function comprises adjusting the audio signal to modify response curves of the audio signal into chosen decay shapes.

7. The method of claim 1, wherein generating the control function comprises activating a low frequency oscillator responsive to a trigger.

8. The method of claim 7, wherein the media input comprises the video signal, and wherein the trigger comprises a visual element present in the video signal.

9. The method of claim 1, wherein generating the control function comprises applying a key to a look up table.

10. The method of claim 9, wherein the key is generated based on at least one selected from the group consisting of (i) the audio signal and (ii) the video signal.

11. The method of claim 9, wherein the look up table is based at least in part on frequency and phase information of the seating unit.

12. The method of claim 1, wherein the media input comprises the video signal, and wherein the control function is generated based on visual elements present in the video signal.

13. The method of claim 1, wherein the media input comprises (i) the audio signal and (ii) the video signal, and wherein generating the control function comprises adjusting frequencies of the audio signal based at least in part on visual elements present in the video signal.

14. The method of claim 1, wherein the control function is generated based at least in part on frequency and phase information of the seating unit.

15. The method of claim 1, wherein the seating unit comprises a chair comprising a seat portion and a back portion, and wherein the haptic device is disposed at one of the seat portion and the back portion, and wherein the haptic device imparts vibration at the seat portion and the back portion.

16. The method of claim 1, wherein the seating unit comprises a stool.

17. The method of claim 1, further comprising adjusting the control function based on a user input.

18. The method of claim 17, wherein the control function comprises a low frequency portion and a high frequency portion, and wherein the haptic device vibrates based on the low frequency portion of the control function, and wherein a speaker system generates an audio output based on the high frequency portion.

19. The method of claim 18, wherein the user input comprises a volume selection between a minimum volume input and a maximum volume input, and wherein, based on the volume selection comprising a first volume level, the relative amplitude of the low frequency portion to the high frequency portion is set to a first value, and wherein, based on the volume selection comprising a second volume level less than the first volume level, the relative amplitude of the low frequency portion to the high frequency portion is set to a second value greater than the first value.

20. The method of claim 18, wherein the user input comprises a boost selection between a minimum boost input and a maximum boost input, and wherein, in response to the boost selection increasing between the minimum boost input and the maximum boost input, (i) a low shelf EQ filter applied to frequencies of the audio signal increases and (ii) an oscillator bank output to an expander module applied to frequencies of the audio signal increases.

21. The method of claim 20, wherein, in response to the boost selection increasing between a first intermediate boost input and the maximum boost input, an output from a sub-harmonic output module applied to frequencies of the audio signal increases, and wherein the first intermediate boost input is greater than the minimum boost input.

22. The method of claim 21, wherein, in response to the boost selection increasing between a second intermediate boost input and the maximum boost input, a threshold at which the expander module is applied to frequencies of the audio signal increases, and wherein the second intermediate boost input is greater than the first intermediate boost input.

23. The method of claim 18, wherein the user input comprises a split selection between a minimum split input and a maximum split input, and wherein, in response to the split selection increasing between the minimum split input and a first intermediate split input, a low pass filter applied to the low frequency portion of the control function increases, and wherein, in response to the split selection increasing between the first intermediate split input and a second intermediate split input greater than the first intermediate split input, the low pass filter is applied to the low frequency portion of the control function and a high pass filter is applied to the high frequency portion of the control function, and wherein, in response to the split selection increasing between the second intermediate split input and the maximum split input, the low pass filter is applied to the low frequency portion of the control function and low mid is applied to the low frequency portion of the control function.

24. The method of claim 18, wherein the user input comprises a balance selection between a minimum balance input and a maximum balance input, and wherein, in response to the balance selection decreasing between the minimum balance input and a first intermediate balance input, the high frequency portion of the control function attenuates at a greater rate than the low frequency portion of the control function, and wherein, in response to the balance selection adjusting between the first intermediate balance input and a second intermediate balance input greater than the first intermediate balance input, the high frequency portion of the control function and the low frequency portion of the control function gain at an equal rate, and wherein, in response to the balance selection increasing between the second intermediate balance input and the maximum balance input, the high frequency portion of the control function gains at a greater rate than the low frequency portion of the control function.

25. A method of controlling a haptic device disposed at a seating unit, the method comprising:
receiving a media input comprising (i) an audio signal and (ii) a video signal;
generating, based at least in part on processing of the media input, a control function corresponding to the media input;
wherein generating the control function comprises adjusting frequencies of the audio signal based at least in part on visual elements present in the video signal;
wherein the control function is generated based at least in part on frequency and phase information of the seating unit; and
wherein, based on the generated control function, a haptic device disposed at a seating unit vibrates to impart vibration at the seating unit.

26. A seating unit, the seating unit comprising:
a seat portion;
wherein a control module generates a control function based at least in part on processing of a media input, and wherein the media input comprises an audio signal;
a haptic device that, based on the control function, vibrates to impart vibration at least at the seat portion of the seating unit;
wherein the control function is generated based at least in part on adjusting frequencies of the audio signal; and
wherein the control function is generated based at least in part on frequency and phase information of the seating unit.

27. The seating unit of claim 26, wherein the control function is generated based at least in part on applying a key to a look up table, and wherein the look up table is based at least in part on the frequency and phase information of the seating unit.

28. The seating unit of claim 27, wherein the media input comprises the audio signal and a video signal, and wherein the key is generated based on at least one selected from the group consisting of (i) the audio signal and (ii) the video signal.

29. The seating unit of claim 26, wherein the seating unit comprises a chair comprising the seat portion and a back portion, and wherein the haptic device is disposed at one of the seat portion and the back portion, and wherein the haptic device imparts vibration at the seat portion and the back portion.

30. The seating unit of claim 26, wherein the control module is disposed remote from the seating unit.
